(19) United States
(12) Patent Application Publication
(10) Pub. No.: US 2025/0356394 A1
(43) Pub. Date: Nov. 20, 2025

(54) NETWORK SYSTEM FOR IMPLEMENTING ON-DEMAND CAMPAIGN MANAGEMENT SERVICES

(71) Applicant: Uber Technologies, Inc., San Francisco, CA (US)

(72) Inventors: Neha Bhatt, San Francisco, CA (US); Rongfei Lu, San Francisco, CA (US); Shiyao Guan, San Francisco, CA (US); Piyush Surana, San Francisco, CA (US); Zhewei Mai, San Francisco, CA (US); Ronald Ouyang, San Francisco, CA (US); Aditya Raghavendra, San Francisco, CA (US); Patricia Benzi, San Francisco, CA (US); Udit Sajjanhar, San Francisco, CA (US); Yeran Zhang, San Francisco, CA (US); Chinmay Deshumukh, San Francisco, CA (US)

(21) Appl. No.: 19/211,841

(22) Filed: May 19, 2025

Related U.S. Application Data
(60) Provisional application No. 63/649,275, filed on May 17, 2024.

(51) Int. Cl. G06Q 30/0242; G06Q 30/0273

(52) U.S. Cl. CPC G06Q 30/0244; G06Q 30/0275

(57) ABSTRACT

A network system operates to enable a user to specify a campaign configuration for a new or existing campaign. Based on the specified campaign configuration, the network system determines one or more campaign execution parameters for configuring an execution of the new or existing campaign on an external content delivery channel, using a data set that is representative of an environment of the external content delivery channel.

### RELATED APPLICATION(S)

This application claims benefit of priority to provisional U.S. Patent Application No. 63/649,275, filed May 17, 2024; the aforementioned priority application being hereby incorporated by reference in its entirety.

### TECHNOLOGY FIELD

Examples pertain to a network system for implementing on-demand campaign management services.

### BACKGROUND

Ad delivery platforms exist for various services and networks. Traditionally, such platforms target content items to users based on contextual information determined about a user. Typically, adjustments to improve the performance and efficacy of the ad delivery platform is learned over-time, through the performance of the ad delivery platform. In some approaches, experimentation is used, where an adjustment is made to the ad delivery platform, and the results are then analyzed. In this regard, processes for tuning and optimizing ad delivery platforms have been limited, sometimes requiring adjustments that impact the operations of the ad delivery platform.

### BRIEF DESCRIPTION OF THE DRAWINGS

The disclosure herein is illustrated by way of example, and not by way of limitation, in the figures of the accompanying drawings in which like reference numerals refer to similar elements, and in which:

FIG. 1 illustrates an example network system for implementing on-demand campaign management services, according to one or more embodiments.

FIG. 2 illustrates an example method for implementing on-demand campaign management service, according to one or more embodiments.

FIG. 3 illustrates an example of a decision tree interface, according to one or more embodiments.

FIG. 4 illustrates a computer system on which one or more embodiments may be implemented.

### DETAILED DESCRIPTION

A network system operates to enable a user to specify a campaign configuration for a new or existing campaign. Based on the specified campaign configuration, the network system determines one or more campaign execution parameters for configuring an execution of the new or existing campaign on an external content delivery channel, using a data set that is representative of an environment of the external content delivery channel.

As used herein, an end user device can correspond to a mobile computing device (e.g., cellular device or smartphone), a desktop computer, a laptop computer, tablet, wearable or other computing device operated by a user. device.

One or more examples described provide that methods, techniques, and actions performed by a computing device are performed programmatically, or as a computer-implemented method. Programmatically, as used, means through the use of code or computer-executable instructions. These instructions can be stored in one or more memory resources of the computing device. A programmatically performed step may or may not be automatic.

One or more examples described can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs, or machines.

Some examples described can generally require the use of computing devices, including processing and memory resources. For example, one or more examples described may be implemented, in whole or in part, on computing devices such as servers, desktop computers, cellular or smartphones, and tablet devices. Memory, processing, and network resources may all be used in connection with the establishment, use, or performance of any example described herein (including with the performance of any method or with the implementation of any system).

Furthermore, one or more examples described may be implemented through the use of instructions that are executable by one or more processors. These instructions may be carried on a computer-readable medium. Machines shown or described with figures below provide examples of processing resources and computer-readable mediums on which instructions for implementing examples described can be carried and/or executed. In particular, the numerous machines shown with examples described include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

### System Overview

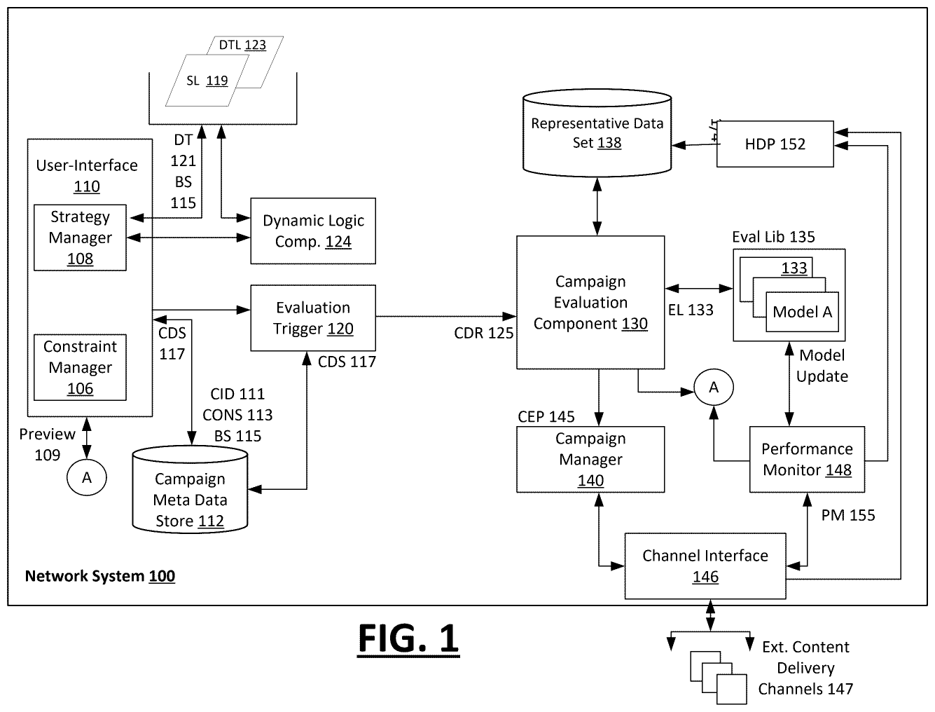

FIG. 1 illustrates an example network system for implementing on-demand campaign management services, according to one or more embodiments. The network system 100 can be implemented on a server, or combination of servers, to communicate with users operating a terminal (e.g., workstation, desktop, laptop, mobile device, etc.). Alternatively, the network system 100 can be implemented in a distributed computing environment, such as one where the functionality described is implemented on multiple computers, including computers operated by the users of the network system that receive the on-demand campaign management services.

In examples, the on-demand campaign management services provided through the network system 100 include operations to facilitate the creation, optimization and management of campaigns on external content delivery channels. Each campaign can involve the placement of commercial content, such as advertisement and promotional media, to end user devices through third-party or external content delivery channels. The external content delivery channels typically implement processes to identify opportunities (sometimes called “slots”) on end user devices where commercial content item can be placed adjacent to, over or with primary content that is being consumed. Each campaign can identify parametric information (e.g., also referred to as campaign execution parameters 145) and bidding strategy that controls implementation of the campaign on the external content delivery channel 147. When an opportunity for content placement is detected on the external content delivery channel 147, an auction process is typically launched to enable campaigns that have relevant content items to bid for the opportunity, with the campaign that places the winning bid receiving the content placement.

Campaigns can be configured to target their audience by geography, demographics, preferences, content channels, and various other characteristics. Generally, the placement of a content item on a given content channel comes at a cost to the campaign, where the cost is typically determined through the auction process. For third-party content channels, the auction processes are external. Campaigns typically include configurations and campaign profile information to enable automated processes associated with the external content delivery channels 147 to implement a bidding process for the opportunities on the end user devices. Each auction process can identify, for example, eligible campaigns based on campaign profile information, such as keywords which identify the target audience of the respective campaign. For each eligible campaign, programmatic processes execute to conduct an auction, where campaigns submit bids in accordance with a bidding strategy and a bidding constraint. As the auction processes are automated, the bidding strategies and constraints that are associated with a particular campaign can determine whether the campaign receives a content placement at a particular opportunity. A user (e.g., advertiser, administrator, etc.) can manage a campaign by configuring the bidding strategy and/or constraints associated with a campaign. Typically, such users configure the campaigns to optimize for one or more objectives of a campaign. By way of example, the objectives of a campaign can include (i) maximizing the return on the cost of advertisement or asset (or investment), sometimes referred to as “ROA” or “ROI”, and/or (ii) maximizing the number or value of a particular activity (e.g., click-throughs, conversions, etc.).

Each external content delivery channel 147 can have an audience that can range into the millions, and each campaign can compete with thousands (if not more) of other campaigns for individual opportunities. Further, each external content delivery channel 147 can have its own dynamic environment comprised of its active audience, the activity and characteristics of the audience, a number of campaigns that compete for placement of content items on the slots of end user devices, and auction processes that are conducted with outcomes. Campaigners seek to optimize their campaigns for audience reach and conversion (e.g., user views content item of campaign, user clicks on content item of campaign, user performs transaction through action on content item of campaign, etc.). Each placement of a content item by a campaign comes at a cost, which is a basis of the cost of the content item. As the auction processes for selecting content items are instantaneous, campaigns are preconfigured to define bidding strategies (e.g., starting with initial bid, bid increments, maximum bid, etc., collectively “bidding parameters”) and constraints (e.g., maximum bid value, etc.). To optimize campaigns, advertisers typically measure conversion events and the cost to the campaign by metrics such as the ROA and ROI. However, under conventional approaches, the ability of advertisers to optimize their campaigns is limited by lack of visibility and delay. To implement a change to a campaign, an advertiser must typically wait hours or days to determine the results of the change. As a result, conventional approaches for managing campaigns typically lack an ability to allow advertisers to make real-time predictions based on the success or failure of changes to existing campaigns and/or bidding strategies.

In contrast to such conventional approaches, the network system 100 provides an on-demand campaign management service that enables an advertiser to design campaigns (e.g., select constraints, bidding strategies and other configurations), to make modifications to campaigns that are in progress, and to view in real-time (or near real-time) a prediction or forecast of the performance of the campaign before the new or modified campaign is executed. The network system 100 is also scalable to host any number of users at one time, and to allow each user to preview the results of a changed or new campaign in advance of execution on the third-party platform. Further, each user can design campaigns and modifications through the ability of previewing the performance of the campaign, thereby enabling the user to generate more sophisticated or customized bidding strategies for use on the external content delivery channels 147.

In examples, the network system 100 includes a user interface 110, a campaign evaluation component 130, a campaign manager 140, and a channel interface 146 to one or multiple external content delivery channels 147. The user interface 110 is configured to enable a user to specify configurations for how a campaign is to be implemented on select external content delivery channels 147. The campaign evaluation component 130 includes processes that determine campaign execution parameters 145 for individual campaigns, based on the configurations specified with the particular campaign. As described with examples, the campaign evaluation component 130 operates in real-time (or near real-time), in response to user input and/or other events (e.g., a recorded change to an existing campaign and/or the creation of a new campaign), to determine campaign execution parameters for the campaign.

In examples, the campaign execution parameters 145 reflect a configuration of the campaign during its execution. For example, the campaign configuration execution parameter(s) 145 can reflect a maximum bidding value a campaign can use when the campaign is executed on an external content delivery channel 147. In some examples, the campaign evaluation component 130 predicts the maximum bid value as an output. Additionally, in examples, the campaign evaluation component 130 can determine the campaign execution parameter(s) 145 as an optimization for the campaign. For example, the campaign execution parameter(s) 145 can specify a maximum bidding value to optimize a ROA of the campaign. The campaign evaluation component 130 can operate to determine one or more campaign execution parameters(s) 145 in advance of the real-world campaign being configured based on the determined campaign execution parameter, in order to enable the user to approve or further modify the particular campaign.

The campaign manager 140 represents processes that execute to manage the real-world execution of individual campaigns on one or more external content delivery channels 147. With reference to FIG. 1, the content channel interface 146 represents processes that communicate with external content channels to initiate and modify campaigns, which may be created, evaluated and configured through the network system 100.

According to examples, the user interface 110 includes interactive features to enable a user to specify various types of configurations for execution of a campaign on one or more external content delivery channels 147. A user may interact with the user interface 110 to view information about an existing campaign, such as a campaign that is ready to execute, or a campaign that is in progress (or being executed). The user interface 110 can include various tools and features to enable users to view metadata and performance metrics (if active) for a campaign, as well as to enable the user to specify constraints and bidding strategies for use with the campaign.

In examples, the user interface 110 can include a constraint interface 106, representing a component or set of features for enabling the user to view, edit, or otherwise specify a set of constraints 113 for a campaign. In context of content delivery campaigns, a constraint corresponds to one or more value(s) and/or condition(s) for a variable (or set of variables) that at least partially defines an optimization objective of the campaign. By way of illustration, examples of constraints can include, (i) a target ROA, (ii) a minimum, maximum or target campaign budget, (iii) a maximum bid value, (iv) a target volume, and (v) a duration for the campaign.

### Strategy Manager

The user interface 110 can also include a strategy manager 108 to enable the user to specify a bidding strategy 115 for a campaign. In examples, the user can interact with the strategy manager 108 to select a predetermined bidding strategy from a collection of bidding strategies 119. A bidding strategy for a campaign can correspond to a set of rules, conditions, data and/or other logic that control the bidding function of the campaign. By way of example, a bidding strategy can designate an initial bid value for an opportunity that satisfies a first condition, an increment value for additional bids, and a maximum bid value for the opportunity. Thus, for example, a bidding strategy for a campaign can designate the operations which are performed to automate the determination of bid values, the determination of budget allocation, and/or the determination of eligible ad entities. The bidding strategies can be optimized for specific objectives. For example, an objective of the bidding strategy can correspond to maximizing the ROA of a campaign.

In examples, the strategy manager 108 can enable a user to modify an existing bidding strategy 115. For example, the strategy manager 108 can identify specific logic, instructions, or parameters used in connection with a bidding strategy 115 that is either associated with the particular campaign, or available as part of the strategy collection 119. A bidding strategy 115 can also include logic that designates the distribution of a budget for the campaign. For example, the bidding strategy 115 can take into account a configuration by which the spend of the campaign is even, front loaded, or back loaded over a duration in which the campaign is to be active. The user may interact with features of the strategy manager 108 to, for example, front load the allocation of budget for the campaign, based on the performance of the campaign.

In additional examples, the user can interact with the strategy manager 108 to change the bidding strategy 115 associated with an existing campaign by, for example, (i) modifying the campaigns that are participating or using a particular strategy for a given channel, (ii) modifying the response activity associated with the strategy (e.g., change optimization for views or clicks to optimization for transactions or transaction value), and/or (iii) designating conditions and/or condition-specific constraints (e.g., change the geographic region associated with the strategy).

In examples, a user can interact with the strategy manager 108 to supplement the collection of bidding strategies, separate from the campaign that may utilize the strategies. For example, a user can create a bidding strategy by modifying an existing campaign strategy, and then storing the modified strategy as a new bidding strategy available with the strategy collection 119. Still further, a user can upload a new algorithm, rule, heuristic set, or model in order to specify logic for implementing the bidding strategy for the campaign.

In some examples, the strategy manager 108 enables the user to create and edit a decision tree 121, from which the user can readily designate conditional statements (e.g., if/then and if/then/else), parameters and/or constraints that are to comprise the campaign strategy. In some variations, the decision tree 121 can be implemented as an interactive component of the strategy manager 108. In an interactive form, the decision tree 121 can receive high-level inputs (e.g., selection input, natural language input, menu specified commands, drag-and-drop inputs etc.) from which the user can specify conditional statements and logical relationships (e.g., BOOLEAN), nested conditional statements, and other logic. Through interaction with the decision tree 121, the user can create or modify a bidding strategy 115 for use with a given campaign, and/or for future use with other campaigns. Once finalized, the bidding strategy 115 generated by the decision tree 121 can be stored in the strategy collection 119, with other strategies.

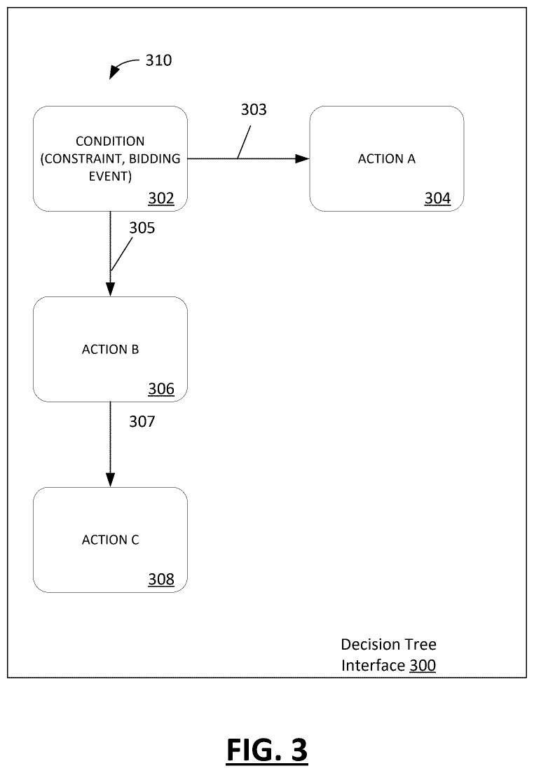

In variations, the strategy manager 108 can also enable users to generate new decision trees 121 by viewing and modifying existing decision trees 121 from a corresponding decision tree collection 123. Further, as described with an example of FIG. 3, the strategy manager 108 can utilize a decision tree interface 300 to enable the user to use interactive elements to create the decision tree 121.

### Campaign Metadata Store

In examples, a campaign metadata store 112 stores metadata sets 117 for each content delivery campaign that is initiated or managed through the network system 100. Each campaign can be associated with a record that includes data representing the campaign identifier 111 and a metadata set 117, where the metadata set identifies the constraints 113 and the bidding strategy 115 used by the campaign. The record can specify the bidding strategy 115 as a reference to one of the bidding strategies of the strategy collection 119.

The user interface 110 can communicate with the campaign metadata store 112 to retrieve, update and/or write the metadata set 117 for each campaign. For an existing campaign, the user can interact with the user interface 110 to specify the campaign identifier, and the user interface 110 can provide a visualization of the campaign and its configurations using a metadata set 117 retrieved from the campaign metadata store 112. The visualization can identify the constraints, bidding strategies and status of individual campaigns (e.g., active, three days remaining). Additionally, the visualization provided for each campaign can identify one or more metrics that represent a performance of the campaign. The displayed metrics can be based at least in part on, for example, the optimization objectives of the campaign (e.g., number of clicks, number of transactions, value of transactions, etc.). Additionally, the user interface 110 can display the metadata set 117 for the campaign. The user can interact with features of the constraint manager 106 to modify or change the constraints associated with the campaign. Additionally, the user can also interact with the strategy manager 108 to modify or replace an existing bidding strategy 115 of the campaign.

For a new campaign, the user can interact with the user interface 110 to generate a campaign identifier 111, as well as to specify a set of constraints 113 and one or more bidding strategies 115 for use by the campaign. The user interface 110 can include processes to cause a corresponding record to be created for the campaign with the campaign metadata store 112, with the record including the campaign identifier 111, the newly specified constraints 113 and references to strategies of the campaign.

### Dynamic Logic Determination

In examples, the network system 100 includes processes, represented by dynamic logic component 124, to generate or otherwise associate executable logic with each bidding strategy of the strategy collection 119. As an addition or variation, the dynamic logic component 124 can include processes that generate the executable logic in response to, for example, the creation of a new strategy by a user. Upon the creation of a new strategy for a campaign, the dynamic logic component 124 can generate, for example, a sequence of program code that can be executed to implement or replicate operations specified by the campaign's bidding strategy, subject to or inclusive of the constraints 113 specified with the campaign. In this way, the executable logic can be associated with the newly generated strategy and/or campaign. The record of the campaign that utilizes a particular strategy can include a reference or link to the corresponding executable logic.

### Change Detection

The evaluation trigger 120 represents processes that trigger the campaign evaluation component 130 to evaluate a campaign. As described with examples, a user can interact with the user interface 110 to update an existing campaign or create a new campaign. The input the user provides to create new campaigns or modify existing campaigns can be stored as part of the metadata set 117 for the campaign. Processes represented by evaluation trigger 120 can generate or otherwise form a campaign data representation 125 for the campaign evaluation component 130. For example, the evaluation trigger 120 can generate the campaign data representation 125 based on user input for the campaign and/or the metadata set 117 associated with the campaign. Further, the evaluation trigger 120 can be triggered in response to the user providing a corresponding trigger input. As an addition or variation, the evaluation trigger 120 can be triggered in response to detection of a change to an existing campaign (e.g., user specifies change to constraint or bidding strategy) as represented in a corresponding record of the campaign metadata store 112. In examples, the campaign data representation 125 can identify, for example, the constraints of the campaign, the bidding strategy used by the campaign, as well as updates or changes to the campaign which may have been made to the campaign by the user through interaction with the user interface 110.

### Campaign Evaluation

The campaign evaluation component 130 includes processes that determine one or more campaign execution parameters 145 for an updated or newly created campaign, based on a corresponding campaign data representation 125. Examples of campaign execution parameters 145 include bidding-related parameters, such as a maximum bid value for the campaign, a mean bid value over the course of the campaign and/or a budget for the campaign. Such bidding values can be probabilistic values (e.g., most likely bidding value for the campaign's execution). As an addition or variation, the campaign execution parameters 145 can reflect a spend or budget for the campaign. For example, if the user specifies a maximum bidding value as a constraint, the campaign evaluation component 130 can predict the spend (e.g., number of views, conversions, etc.) if the constraint is present. Still further, other examples of campaign execution parameters 145 include parameters that identify a target audience or market for the campaign, such as a geographic market or a particular external content channel 147.

The campaign evaluation component 130 can be triggered by, for example, user input detected via user interface 110 to initiate evaluation of an updated or new campaign. In response to such an event trigger, the campaign evaluation component 130 performs operations to determine one or more campaign execution parameters 145 for the campaign. The campaign evaluation component 130 can perform the operations synchronously, meaning the output is determined in real-time (or near real-time), in response to a triggering event. In examples, the triggering event can include a user input, which may be provided via the user interface 110, in connection with the user specifying an update or new campaign. In variations, the triggering event can correspond to the detection of the changed or new campaign. In other examples, the triggering event can be predefined.

In determining campaign execution parameters 145 for a campaign, the campaign evaluation component 130 selects an evaluation logic 133 from an evaluation logic library 135 and applies the evaluation logic to a data set that is representative of the relevant market for the campaign. Different sets of evaluation logic 133, including evaluation models, can be provided with the evaluation logic library 135. For example, the evaluation logic library 135 can include historical evaluation logic (e.g., previously used), as well as evaluation logic 135 specified for a particular campaign by a user. Further, the campaign evaluation component 130 can implement evaluation logic for optimizing by bidding strategy, keywords and/or other criteria. The network system 100 maintains a representative data set 138 that is representative of the content delivery environment for one or more external content delivery channels 147. As described in greater detail, the representative data set 138 can include data sets that parallel or simulate the campaign environment of each of the external content delivery channels 147. In examples, evaluation logic 133 used by the campaign evaluation component 130 can include rule sets and/or predictive models that execute using the representative data set 138.

The campaign evaluation component 130 can select an evaluation logic 133 from the evaluation logic library 135 based on one or more attributes of the specified campaign. In examples, the campaign evaluation component 130 can select the evaluation logic 133 based on the bidding strategy specified by the campaign. For example, if the campaign data representation 125 identifies a previously known bidding strategy, the campaign evaluation component 130 can select an evaluation logic 133 that is previously used or associated with the bidding strategy. If the bidding strategy is newly designed (e.g., designed by the user via the strategy manager 108), the campaign evaluation component 130 can select the evaluation logic 133 based on a comparison of the bidding strategy to other bidding strategies that are known and previously associated with evaluation logic of the library 135. In this way, the selected evaluation logic 133 can be specific to the bidding strategy. For example, the campaign evaluation component 130 can evaluate the campaign using the campaign data representation 125 and one or more models that were previously used by other campaigns which utilize the same bidding strategy.

Still further, in examples, the campaign data representation 125 can indicate a type of campaign execution parameterization that is requested for output. For example, the user may specify, via the user interface 110, the constraint of a target ROA, in which case the requested output can correspond to a maximum or optimal bid value for the campaign to achieve the target ROA. Accordingly, in examples, the selected evaluation logic 133 can be based on the type of campaign execution parameter being requested by the user through the user interface 110.

In examples, the campaign evaluation component 130 selects one or more models as the evaluation logic 133. In some examples, the evaluation logic library 135 can include predictive models that generate probabilistic determinations of bidding values (e.g., maximum bidding value, mean bidding value, optimal bidding value, and/or bidding increment) for the campaign, given the campaign data representation 125. As an addition or variation, the evaluation logic library 135 can include logic for determining optimal sets of keywords for a given campaign, as well as ranking keywords of the set, and/or identifying values (e.g., bidding values) for individual keywords of the optimal set.

In determining bidding values and other types of campaign execution parameters 145, the campaign evaluation component 130 executes the selected evaluation logic on a representative data set of the external content channel(s) 147 where the campaign is being or will be executed. The representative data set 138 can be aggregated from multiple sources to reflect different aspects of channels and markets where the campaigns are executed.

### Representative Data Set

In examples, the representative data set 138 is generated to represent the campaign environment of each external content delivery channel in a relevant time period. The campaign environment for each content delivery channel can reflect opportunities (or slots, inventory, etc.), contextual information associated with the opportunities, bidding activities of third parties on the same channel, the auction processes and/or their respective outcomes, and/or other characteristics or attributes which are potentially impactful to campaigns. In examples, the representative data set 138 can also include data that represents bidding strategies and constraints used by campaigns (including third-party campaigns) that execute on the external content delivery channels. The representative data set can be structured to represent, for example, the audience (or available inventory) of specific external content delivery channels, as well as segments of the population by criteria such as geography.

In examples, the representative data set 138 can be generated and maintained utilizing historical channel activity data obtained from the content delivery channels 147. The network system 100 can implement processes represented by the historical data processing component (“HDP 152”) to periodically retrieve historical channel activity data relating to content delivery activities and other aspects of the campaign environment on the external content delivery channels 147. The historical channel activity data can include, for example, aggregate and summary information relating to activities performed on the different external content delivery channels 147 (e.g., number of auctions conducted over a period of time, average winning bids, etc.). Additionally, the HDP 152 can process campaign performance information received from, for example, performance monitor 148, relating to campaigns managed through the network system 100 on the external communication channels 147. This campaign performance information can include winning bids (or “final cost per action” (“FCPA”)), impressions (for individual campaign) and other touch point data (e.g., views, action the user takes upon seeing the campaign content such as opening an application or clicking or performing another type of conversion event). Accordingly, in some examples, the campaign performance information can include events such as, for example, the number of campaigns that are active, the bidding activities of the individual campaigns, the winning bids, and the contextual information associated with the respective campaigns (e.g., keywords) that each auction process used to identify the campaign as a candidate. The campaign performance information can also include identification of opportunities (e.g., slots on end user devices), as well as contextual information associated with the slots (e.g., geography, characteristic of user, time of day, etc.).

Further, in some examples, the HDP component 152 can include processes that featurize and validate the retrieved information. The featurization of the historical data can include structuring or transforming the historical channel activity data and the campaign performance information into parametric information that is suitable for the models of the evaluation logic store 135. In this way, the representative data store 138 can reflect, for example, an audience state for markets of the external content delivery channels 147. In examples, the representative data set 138 can be periodically or continuously refreshed, such that the historical information used is sufficiently recent (e.g., less than 1-2 days old, current up to last hour, etc.). In this way, the representative data set 138 is fresh and more accurately representative of the campaign environments of the external content delivery channels 147.

Further, the models of the evaluation logic store 135 can be trained and updated on the representative data set 138. As described in more detail, the network system 100 can include processes to (i) compare the predicted results generated by the campaign evaluation component 130 with observed results of the external content channel, and (ii) update or tune the individual models based on the comparisons. In this way, the models can be trained on the representative data set 138, and updated by events of the external content delivery channels 147, so as to be accurately representative of the campaign environment of the content delivery channels 147.

According to examples, the campaign evaluation component 130 can respond to an evaluation trigger by selecting and executing a predictive model from the evaluation logic library 135. The campaign evaluation component 130 can execute individual models 133, representative data set 138, to predict bidding values or other campaign execution parameters 145 for the campaign identified by the campaign data representation 125. The campaign evaluation component 130 can also implement models or other logic that can tune the campaign execution parameters 145 for specific content delivery channels 147 or other campaign attributes that are used by the particular result. In such examples, the campaign execution parameters 145, as determined by the campaign evaluation component 130, can be based on the model's execution with respect to relevant representative data 138, but the output result can also be tuned for specific attributes of the identified campaign (e.g., the content channel in use).

In examples, the campaign evaluation component 130 generates the campaign execution parameters 145 (e.g., maximum bidding value) in real-time, or near real-time with respect to when the change detection is made with respect to the campaign. In some examples, the campaign execution parameters 145 are determined and communicated to the user interface 110, to enable a user to preview the campaign execution parameters 145 for a given campaign or campaign modification. Further, in examples, the user can interact with the user interface 110 to have the update to the campaign (as provided by the campaign data representation 125 and evaluated by the campaign evaluation component 130) implemented in the execution of the campaign. For example, a user can interact with the user interface 110 to increase the desired ROA for an existing campaign, resulting in a constraint change that is detected and evaluated by the campaign evaluation component 130. In response to the detected change, the campaign evaluation component 130 can generate campaign execution parameters 145 that correspond to a new set of bidding values (e.g., maximum bidding value, mean bidding value, etc.) for the campaign, where the bidding values are predicted values that will allow the campaign to meet the desired ROA. The campaign execution parameters 145 can be displayed as part of a preview 109, via the user interface 110, and the user can interact with the user interface 110 to have the existing campaign changed in accordance with the campaign execution parameters 145.

In some variations, the campaign evaluation component 130 implements keyword optimization logic, such that the campaign evaluation parameter(s) can identify individual key words for bidding, as well as key word ranking metrics (e.g., priority ranking of individual key words for purpose of bidding and allocation), and/or keyword pricing parameters (e.g., optimal amounts campaign should expend on corresponding keywords).

As an addition or variation, once the campaign execution parameters 145 are determined and communicated to the user via the user interface 110, the user can explore alternative campaign configurations through manual interaction with the user interface 110. For example, the user can change the bidding strategy, make modifications to the existing bidding strategy, make further adjustments to the ROA, change the target audience for the campaign, increase the campaign's budget, increment the maximum bid value and/or specify any one of a variety of different configurations for the campaign. The campaign evaluation component 130 can process alternative configurations and changes in response to the user input, with updated campaign execution parameters 145 being displayed to the user in near-real time to enable the user to select the configuration for the particular campaign.

Further, in some examples, the campaign evaluation component 130 can also utilize models, or other resources to provide rationale and/or recommendations in connection with the campaign evaluation parameters 145. The rationale can provide a basis or reason for the campaign execution parameters 145, while the recommendations can identify modifications to or suggestions with regard to implementation of the campaign (e.g., bidding strategy or other campaign metric). For example, the campaign evaluation component 130 can utilize trained, machine-learned algorithms for providing the rationale and/or recommendations. In other examples, the campaign evaluation component 130 can utilize a large language model (LLM) service to analyze the response and provide correlations from which rationale and recommendations can be determined.

### Campaign Management

The campaign manager 140 represents processes that (i) implement changes to campaigns that are executing on external content delivery channels 147 based on the corresponding campaign data representation 125 and the selected campaign execution parameters 145, and (ii) initiate new campaigns in accordance with the campaign data representation 125 and the selected campaign execution parameters 145. The campaign manager 140 can, for example, maintain a data store that tracks the configurations and results of each campaign. When the user subsequently interacts with the user interface 110 to implement a change for achieving the campaign execution parameters 145, the campaign manager 140 can implement the change on the live campaign, and further communicate the change to the appropriate external content delivery network via the channel interface 146.

While in some examples the user can preview the campaign execution parameters 145 along with other information about the campaign, in variations, the campaign manager 140 can automatically implement changes to an existing campaign, or initiate a new campaign, on the external content delivery channels 147. The campaign manager 140 can implement the changes based on the campaign data representation 125 and the campaign execution parameters 145. In this way, the campaign evaluation component 130 can be said to make real-time (or near real-time) determinations, in response to a triggering event in which a campaign is updated or newly created, and further analyzed by the campaign evaluation component 130. Further, the campaign evaluation component 130 can operate in an environment where multiple users access the network system 100 to generate predictions or determinations of bid values or other campaign execution parameters 145, for specified campaigns, subject to further changes after the campaign execution parameters 145 are previewed.

Among other advantages, the synchronous aspect of the campaign evaluation component 130 enables workflows that allow for user interaction with predicted bidding values, in real-time, utilizing accurate and fresh data representations of the campaign environments provided by the external content delivery channels 147. For example, the campaign evaluation component 130 can generate accurate, predictive bidding values for use with third-party content delivery channels 147. Further, the bidding values can be generated instantaneously, or near instantaneously, to allow for a workflow where the user can make adjustments to the constraint or strategy being deployed to manually tune the configuration for the desired objective.

### Performance Monitoring

The network system 100 can also include processes represented by performance monitor 148. The performance monitor 148 can interface with the external content delivery channels 147 via the channel program interface 144, to determine performance metrics 155 for active campaign that are managed through the network system 100. The performance metrics 155 can reflect or correspond to a real-world measurement of the campaign execution parameters 145 (e.g., bid values), as determined by the campaign evaluation component 130. For example, the performance monitor 148 can determine the maximum bidding amount that is to be used by a campaign that was modified through user input.

The performance monitor 148 can also include additional metrics, such as the ROA, ROI or other efficiency parameter of the campaign. The measurements made by the performance monitor 148 can be stored as part of the campaign record and stored with the campaign metadata store 112. The measurements can also be displayed on the user interface 110, with the campaign execution parameters 145 providing a basis for comparison. Further, in some examples, the performance monitor 148 can include a program interface and/or user interface, to receive and implement external logic that defines the ROA or ROI for specific campaigns. In this way, the ROA or ROI used to determine performance can vary from campaign-to-campaign. Further, in some cases, the ROA or ROI can be defined for specific campaigns. For example, the ROA or ROI can be defined at least in part by campaign-specific formulas and/or metrics.

In some examples, the performance monitor 148 can also utilize models, or other resources (e.g., LLM service) to provide rationale and/or recommendations as to the performance of individual campaigns. For example, if the performance metrics 155 observed for a given campaign does not match a predicted result, the performance monitor can utilize trained machine-learned models and/or an LLM service to analyze the performance metrics and determine correlations, from which the basis of the performance metrics 155 can be inferred and communicated back to the user.

### Methodology

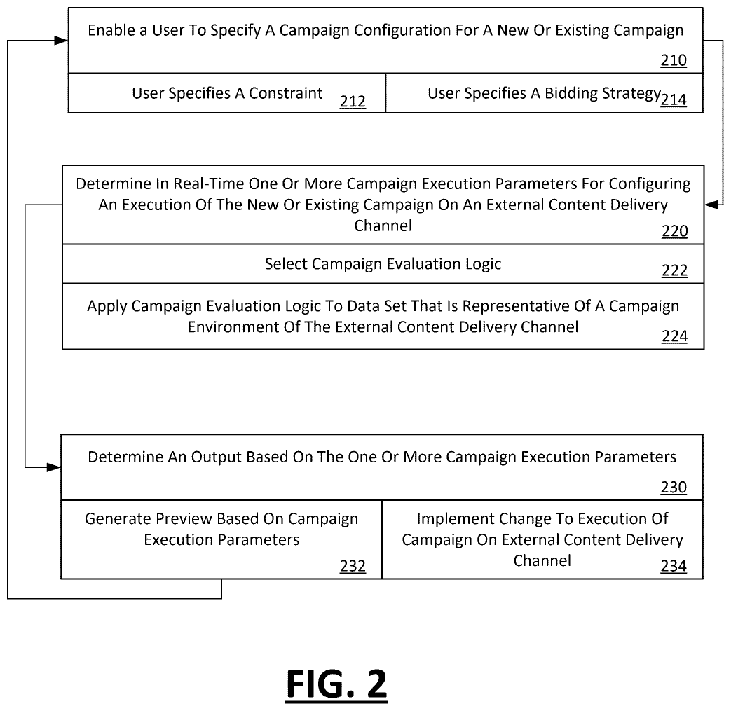

FIG. 2 illustrates an example method for implementing on-demand campaign management service, according to one or more embodiments. A method such as described with an example of FIG. 2 can be implemented using components and functionality described with an example of FIG. 1. Accordingly, reference is made to elements of FIG. 1 for purposes of illustrating suitable functionality for performing a step or sub-step being described.

In step 210, the network system 100 enables a user to specify a campaign configuration for a new or existing campaign. The user can interact with the user interface 110 to specify a change to an existing campaign (e.g., a campaign that is in progress with an external content delivery channel 147). In step 212, the user input can specify a constraint, such as a desired or target ROA. In step 214, the user input can specify an input corresponding to a bidding strategy for the campaign. The user can modify an existing bidding strategy or create a new one. In examples, the network system 100 includes a collection of bidding strategies from which the user can make a selection. As an addition or variation, the user can form a new bidding strategy by selecting an existing strategy and then modifying it. Alternatively, the user can utilize an interactive decision tree to specify rules and conditions that collectively comprise a bidding strategy.

In step 220, the network system 100 determines, in real-time, one or more campaign execution parameters 145 for configuring execution of the new or existing campaign on an external content delivery channel 147. As described with other examples, the campaign execution parameter(s) 145 correspond to control parameters for the execution of the campaign on the external content delivery channel 147. For example, the content execution parameters can reflect the bid value for the campaign, such as a maximum bid value that the campaign may utilize in an auction process.

In step 222, the network system 100 selects a campaign evaluation logic 133 for determining a set of campaign execution parameters 145, based on the campaign configuration. In step 224, the campaign evaluation logic 133 is applied to a data set 138 that is representative of the campaign environment of the external content delivery channel. For example, the data set can be determined from monitoring and evaluating campaign performance information, as described with previous examples. The data set can also be determined and/or validated from channel activity data, reflecting, for example, summary or aggregate information about activities performed on the respective external content delivery channels 147. The data may be periodically obtained in preprocessed, such that the data is featurized in a manner that reflects the environment of the external content delivery channels 147.

In examples, the campaign evaluation logic 133 includes predictive models. For example, predictive models can be used to predict the optimal bidding value for the execution of the campaign on an external content delivery channel 147. Such models can be trained using, for example, a data representation that is developed from historical channel activity data and campaign performance information. However, in examples, the predictive determinations of the individual models can be compared to real-world metrics for the same campaigns, in order to continuously tune or train the models on real-world data generated by execution of the campaign on an external content delivery channel 147. Thus, for example, the performance monitor 148 can record the performance of a campaign, particularly with respect to the bidding strategy. The result can be compared to the predictive determinations of the model that was used, in order to determine the variation between the predictive and real-world measurement. The performance monitor 148 can use a value that is based on the comparison to update, tune or otherwise train the respective model that was used.

In step 230, the network system 100 determines an output based in the one or more campaign execution parameters. In step 232, the output can be generated as a preview 109, such as displayed on the user interface 110, based on campaign execution parameters determined by application of the campaign evaluation logic on the representative data set. Following step 232, steps of an example method as shown can then be repeated from step 210, where the user can specify additional configurations to the campaign upon viewing the preview. The additional configurations can be processed again, to determine in update to the campaign execution parameters 145 and the output generated from the campaign evaluation component 130.

As an addition or variation, in step 234, the output generated from the campaign evaluation component 130 can include commands or instructions that cause the campaign manager 140 to implement changes to the execution of the specified campaign on an external content delivery channel. For example, the campaign manager 140 can automatically implement changes to a campaign that is a flight, based on determined campaign execution parameters.

### Decision Tree Interface

FIG. 3 illustrates an example of a decision tree interface 300, according to one or more embodiments. The decision tree interface 300 enables the user to dynamically generate a logical data structure that specifies rules and conditions for implementing a bidding strategy for campaign during its execution in a real-world environment. The decision tree interface 300 can include interactive elements that can be arranged in accordance with logical relationships and conditions. For example, the user can specify cells, connections and/or conditions for connections, based on selectable features, such as drag-and-drop cells and interactive features, selectable operators, and text entry box where users can manually specify conditions constraints and other values.

By way of example, the decision tree interface 300 can visualize a conditional statement, such as provided by an if/then statement. In an example shown, first cell 302 of the tree structure 310 can include a first conditional statement (e.g., if bid value is less than a designated value). The first cell 302 can include a logical connection 303 to a second cell 304, which follows if the conditional statement of the first cell is true (or false, as may be designated). The first cell 302 can also include a second connection 305 that connects to a third cell 306, which follows if the conditional statement is false (or true, as may be alternatively designated). In the example shown, the cell 306 includes an alternative action (e.g., generate initial bid based on constraint). Likewise, in the example, the flow can proceed to cell 308 where another action is performed (e.g., make a second bid based on increment value). The user can continue to interact with the design tree interface 300 to specify additional cells (e.g., conditional statements, actions, etc.) in order to specify the bidding strategy in various levels of detail. In this way, the conditional statements, actions and other events can be added or edited to the tree structure 310 as a mechanism for the user to specify the bidding strategy for the campaign in detail.

In examples, the user can use interactive elements of the design tree interface 300 to fully develop a bidding strategy. Once complete, the user can submit the bidding strategy. The network system 100 can implement processes, such as represented by the dynamic logic component 124, to generate executable code or logic to represent the decision tree 310. The executable logic can be stored in association with the bidding strategy and/or decision tree 310. Further, the executable code can be used by the campaign evaluation component 130 to simulate the bidding process of a campaign where the bidding strategy is in use.

### Hardware Description

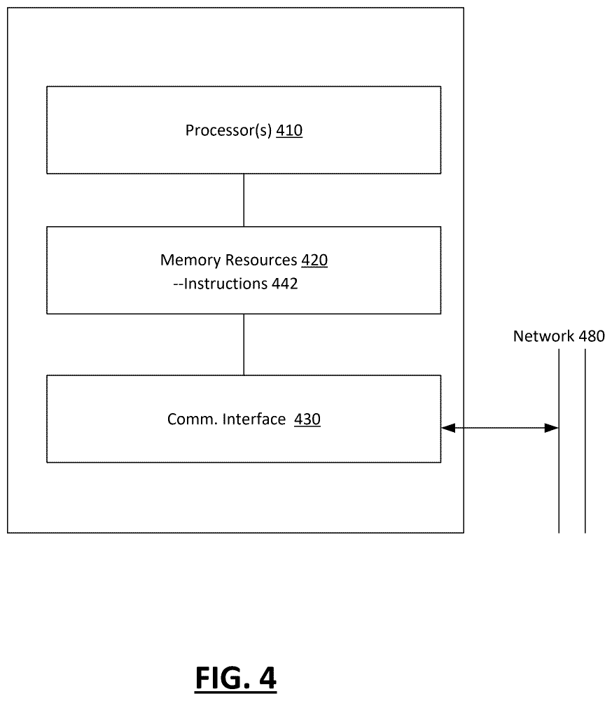

FIG. 4 illustrates a block diagram that illustrates a computer system on which examples described herein may be implemented. For example, in the context of an example of FIG. 1, the network system 100 can be implemented using a computer system or combination of computer systems, such as described by FIG. 4.

In one implementation, the computer system 400 includes one or more processors 410, memory resources 420, and a communication interface 430. The computer system 400 includes at least one processor 410 for processing information. The memory resources 420 may include a random access memory (RAM) or other dynamic storage device, for storing information and instructions to be executed by the processor(s) 410. The memory resources 420 also may be used for storing temporary variables or other intermediate information during execution of instructions to be executed by the processor(s) 410. The computer system 500 may also include other forms of memory resources, such as static storage devices for storing static information and instructions for the processor 410. The memory resources 420 can store information and instructions, including instructions 442 for implementing processes of network system 100. Additionally, the processor(s) 410 can execute the instructions 442 to implement a method such as described with respect to examples of FIG. 2.

The communication interface 430 can enable the computer system 400 to communicate with one or more networks 480 (e.g., cellular network) through use of the network link (wireless or wireline). Using the network link, the computer system 400 can communicate with one or more other computing devices and/or one or more other servers or data centers. In some variations, the computer system 500 can receive device data and/or service-specific information from the user device, as well as other computer systems, such as those operated by third parties.

Examples described herein are related to the use of the computer system 400 for implementing the techniques described herein. According to one embodiment, those techniques are performed by the computer system 400 in response to the processor 410 executing one or more sequences of one or more instructions contained in the memory resource 420. Such instructions may be read into the memory resources 420 from another machine-readable medium, such as the storage device. Execution of the sequences of instructions contained in the main memory 420 causes the processor 410 to perform the process steps described herein. In alternative implementations, hard-wired circuitry may be used in place of or in combination with software instructions to implement examples described herein. Thus, the examples described are not limited to any specific combination of hardware circuitry and software.

It is contemplated for examples described herein to extend to individual elements and concepts described herein, independently of other concepts, ideas or system, as well as for examples to include combinations of elements recited anywhere in this application. Although examples are described in detail herein with reference to the accompanying drawings, it is to be understood that the concepts are not limited to those precise examples. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mention of the particular feature. Thus, the absence of describing combinations should not preclude having rights to such combinations.

What is claimed is:

1. A network system comprising:
one or more processors;
a memory to store instructions;
wherein the one or more processors execute the instructions to perform operations comprising:
enabling a user to specify a campaign configuration for a new or existing campaign;
in response to the user specifying the campaign configuration, determining, based on the specified campaign configuration, one or more campaign execution parameters for configuring an execution of the new or existing campaign on an external content delivery channel, using a data set that is representative of an environment of the external content delivery channel; and
determine an output based on the one or more campaign execution parameters.

2. The network system of claim 1, wherein the one or more campaign execution parameters are determined synchronously, in response to the user specifying the campaign configuration.

3. The network system of claim 1, wherein determining one or more campaign execution parameters includes selecting a campaign evaluation logic from a plurality of campaign evaluation logics, and executing the campaign evaluation logic using the representative data set.

4. The network system of claim 1, wherein determining a campaign data representation for the new or existing campaign, the campaign data representation being indicative of the campaign with the specified configuration; and
wherein determining the one or more campaign execution parameters is further based on the campaign data representation.

5. The network system of claim 1, wherein the specified campaign configuration is based on an input of the user that specifies a constraint of the campaign.

6. The network system of claim 1, wherein the specified campaign configuration is based on an input of the user that specifies a bidding strategy, a change to an existing bidding strategy, or a new bidding strategy.

7. The network system of claim 6, wherein the specified campaign configuration is based on a decision tree that specifies at least a portion of the bidding strategy.

8. The network system of claim 3, wherein the campaign evaluation logic includes a predictive model, and wherein executing the campaign evaluation logic includes executing the model to predict a campaign execution parameter that corresponds to a predicted bidding value for the campaign.

9. The network system of claim 8, wherein the operations further comprise:
providing, on the user interface, a preview of the campaign configuration when executed on the external content delivery channel, the preview including the predicted bidding value.

10. The network system of claim 9, wherein the operations further comprise:
in response to providing the preview, enabling the user to interact with the user interface to modify the campaign configuration, and in response to the user modifying the campaign configuration, updating the campaign data representation and executing the campaign evaluation logic to synchronously determine an update to the one or more campaign execution parameters.

11. The network system of claim 1, wherein the operations further comprise:
configuring an execution of the campaign on an external content delivery channel based on the specified campaign configuration and the one or more campaign execution parameters.

12. The network system of claim 1, wherein the operations further comprise:
generating a preview on a user interface, the preview identifying an optimal bid amount, and wherein the operations further comprise enabling the user to select to implement bid determination logic in response to the preview.

13. A non-transitory computer-readable medium that stores instructions, which when executed by one or more processors of a network system, cause the network system to perform operations that include:
enabling a user to specify a campaign configuration for a new or existing campaign;
in response to the user specifying the campaign configuration, determining, based on the specified campaign configuration, one or more campaign execution parameters for configuring an execution of the new or existing campaign on an external content delivery channel, using a data set that is representative of an environment of the external content delivery channel; and
determine an output based on the one or more campaign execution parameters.

14. The non-transitory computer-readable medium of claim 13, wherein the one or more campaign execution parameters are determined synchronously, in response to the user specifying the campaign configuration.

15. The non-transitory computer-readable medium of claim 13, wherein determining one or more campaign execution parameters includes selecting a campaign evaluation logic from a plurality of campaign evaluation logics, and executing the campaign evaluation logic using the representative data set.

16. The non-transitory computer-readable medium of claim 13, wherein determining a campaign data representation for the new or existing campaign, the campaign data representation being indicative of the campaign with the specified configuration; and
wherein determining the one or more campaign execution parameters is further based on the campaign data representation.

17. The non-transitory computer-readable medium of claim 13, wherein the specified campaign configuration is based on an input of the user that specifies a constraint of the campaign.

18. The non-transitory computer-readable medium of claim 13, wherein the specified campaign configuration is based on an input of the user that specifies a bidding strategy, a change to an existing bidding strategy, or a new bidding strategy.

19. The non-transitory computer-readable medium of claim 18, wherein the specified campaign configuration is based on a decision tree that specifies at least a portion of the bidding strategy.

20. A computer-implemented method comprising:
enabling a user to specify a campaign configuration for a new or existing campaign;
in response to the user specifying the campaign configuration, determining, based on the specified campaign configuration, one or more campaign execution parameters for configuring an execution of the new or existing campaign on an external content delivery channel, using a data set that is representative of an environment of the external content delivery channel; and
determine an output based on the one or more campaign execution parameters.
